(19) United States
(12) Patent Application Publication
(10) Pub. No.: US 2013/0030762 A1
(43) Pub. Date: Jan. 31, 2013

(54) METHOD FOR CALCULATING DOSES DEPOSITED BY IONIZING RADIATION

(71) Applicants: David Mercier, Dourdan (FR); Baptiste Blanpain, Versailles (FR); Jean Barthe, Saint-Orens De Gameville (FR)

(72) Inventors: David Mercier, Dourdan (FR); Baptiste Blanpain, Versailles (FR); Jean Barthe, Saint-Orens De Gameville (FR)

(73) Assignee: COMMISSARIAT A L'ENERGIE ATOMIQUE ET AUX ENERGIES ALTERNATIVES, Paris (FR)

(21) Appl. No.: 13/384,104

(22) PCT Filed: Jul. 13, 2010
(86) PCT No.: PCT/EP2010/060088

§ 371 Date: Aug. 9, 2012

(30) Foreign Application Priority Data
Jul. 15, 2009 (FR) 0954870

(51) Int. Cl. G06F 17/18

(52) U.S. Cl. 702/179

(57) ABSTRACT

A method for calculating loads deposited by an ionizing radiation, for example to be used by a radiotherapy therapeutic treatment device. The method includes at least one first step of calculating a function of the distribution of the load in the meshes of a mesh phantom. The method includes a second step of calculating the load deposited in a voxel assembly, the value of the deposited load for one voxel being given by the function of the distribution of the load particular to the mesh to which the voxel belongs. The invention can be used in particular for radiotherapy by intensity modulation.

The present invention relates to a method for calculating doses deposited by ionizing radiation, for example used by a device for therapeutic treatment by radiotherapy. The invention can notably be applied to intensity modulated radiotherapy.

Radiotherapy is a technique for treating cancer one of the principles of which is to destroy one or more tumors. The destruction of the tumor is performed by means of successive external irradiations by beams of ionizing rays, while safeguarding to the maximum the healthy tissues. The operative mode requires morphological knowledge of the tumor as well as accurate location thereof in the organism of the patient. This information is obtained with the aid of images arising from a scanner or else of images obtained by magnetic resonance. An irradiation protocol is then determined by an oncologist doctor with the help of a treatment planning system. The irradiation protocol defines notably the energy of the beams, their shape, their position and their angle of incidence on the tumor. The whole difficulty consists in choosing the best parameters, that is to say those which will make it possible to achieve the most effective and safest dose distribution for treating the patient. The dose represents an amount of energy deposited in a small volume of the organism of the patient. The dose is directly related to the impact of the treatment in regard to destruction of cells. The dose is therefore the reference quantity used in radiotherapy.

In particular, the principle of intensity modulated radiotherapy, or IMRT, is notably to perform an irradiation along fixed directions. The total dose is deposited in several tens of irradiations, carried out at different angles. For each direction, the shape of the beam is adapted to that of the tumor. Each beam can, moreover, be modulated spatially in fluence so as notably to adapt to the characteristics of the patient. The fluence is a quantification of the number of particles of the beam, corresponding to the intensity of the beam. It is thus possible to irradiate the tumor sufficiently to destroy it, while limiting the irradiation of the healthy parts so as to minimize the undesirable side effects of the radiotherapy. Thus, the oncologist doctors indicate for each zone to be treated a minimum dose for the tumor or a maximum dose for the healthy organs. The oncologist doctors therefore propose an irradiation protocol with the aid of their experience. To validate the irradiation protocol, the doctors can employ tools for calculating a spread of the dose in the patient according to the protocol advocated.

Several existing procedures make it possible to calculate the dose deposited by ionizing radiations in a patient. These procedures may be grouped into two categories:
very accurate procedures, such as the Monte Carlo procedure, require calculation times that are too long to be used in-clinic and notably when devising a treatment protocol. Indeed, one of the objectives of an oncologist is that at the end of a consultation with a patient, he can immediately fix dates of radiotherapy sessions. The oncologist therefore has about twenty or so minutes to validate the protocol that he has tailored. Moreover, if optimization of the protocol is desired by the oncologist, it is necessary for the dose calculations to take only a few seconds, it thus being possible for the dose calculations to be iterated within the framework of the optimization process. Accurate procedures such as these are too expensive in terms of calculation time to be used within this framework.
faster procedures such as the Clarkson, Pencil Beam, Kernels procedures, are in general very insufficient in terms of accuracy. Poor accuracy of the results obtained can place the patient's life in danger. Indeed, a patient is composed of various materials: flesh, water, bone, of different electronic composition and density. The transitions between two materials crossed successively by a beam can lead to an electronic disequilibrium at the level of the interface between the two materials which significantly modifies the dose deposited in the vicinity of the interfaces. Fast procedures have approximate, or indeed nonexistent, management of the electronic disequilibrium at the interfaces. For example, in the vicinity of complex interfaces, the calculation errors can exceed 15% of the dose actually deposited. In the case of under-dosing of the radiations on the tumor, this can imply the survival of certain cells and therefore the ineffectiveness of the treatment. In the case of overdosing on critical organs, such as the spinal cord or the optic nerve, this can imply irreversible damage to these organs. Moreover, even if these procedures are faster than procedures of Monte Carlo type, they do not offer a sufficiently short calculation time to be usable for the automatic optimization of treatment planning.

The so-called Monte Carlo procedure is notably described by Andreo P. in 1991, in the document: “Monte Carlo techniques in medical radiation physic, Phys. Med. Biol. 36, 861-920”, and by Salvat F., Fernandez-Varea J., Acosta E. & Sempau J. in 2006, in the document: “PENELOPE-2006, A Code System for Monte Carlo Simulation of Electron and Photon Transport, in NEA 6222, ISBN: 92-64-02301-1”. The Monte Carlo procedure utilizes a microscopic and statistic physical model of radiation-matter interactions: trajectories of beam particles are simulated by successive random drawings of probabilities of interactions between the particles and the material that they penetrate. In order for the result to be statistically acceptable, a large number of trajectories are simulated: of the order of 10⁷. The dose released by the various interactions is then aggregated in the voxels of the volume bombarded by the particles. A voxel may be defined as the smallest element of a digitized three-dimensional space: it is as it were a volumetric pixel. The large number of trajectory calculations requires a very appreciable calculation time, of the order of several hours on a conventional computer.

A procedure termed “Phase Space Evolution” is notably described by Huizenga, H. & Storchi, P. R. M. in 1989, in “Numerical calculation of energy deposition by broad high-energy electron beams, Phys. Med. Biol. 34, 1371-96”, and by Janssen, J. J.; Riedeman, D.; Morawska-Kaczynska, M.; Storchi, P. R. M. & Huizenga, H. in 1994, in “Numerical calculation of energy deposition by high-energy electron beams: III. Three-dimensional heterogeneous media, Phys. Med. Biol. 39, 1351-66”. This procedure consists, within a given volume, in transporting, from voxel to voxel, fluxes of electrons, sampled according to their energy and their angle of displacement. This makes it necessary to employ, in databases, for each group of electrons of given energy, arriving at a voxel with a given direction, models giving a distribution in terms of energy and angle of the electrons emerging from the voxel. The models giving the energy distribution are notably called distribution functions. The distribution functions are pre-calculated with the aid of physical equations, but they can also be so calculated with the aid of simulations of Monte Carlo type such as described previously. The “Phase Space Evolution” procedure using pre-calculated data, it is faster than a Monte Carlo procedure. However the calculation time that it requires still remains very appreciable.

Another approach, fairly similar as regards the physical principle, consists in solving the macroscopic equations for the transport of electrons and photons by the finite element technique. For example Gifford K. A., Horton J. L, Wareing T. A., Failla G and Mourtada F present this approach with the linear equation for Boltzmann transport in ‘Comparison of a finite-element multigroup discrete-ordinates code with Monte Carlo for radiotherapy calculations’, Physics in Medicine and Biology, 51, 2253-2265, 2006. The physical quantity of interest is the fluence which is here a multivariable function defined at any point, for any direction, for the various types of particles considered and for any energy level of each type of particle. This function is in practice and according to the very principle of the finite element technique, quantized according to the directions and the energy levels of the particles. Said function is spatially projected onto a local decomposition basis such as Legendre polynomials. The solution is global. The dose in a small volume is thereafter calculated with the aid of the expression for the fluence. It not being possible for the quantization according to the directions and the energy levels to be too coarse for fear of being too inaccurate, this procedure requires a consequent memory size and the calculation times are still appreciable.

In order to accelerate the dose calculations, it has been proposed to use three-dimensional distributions of doses pre-calculated by a Monte Carlo procedure on homogeneous phantoms so as to reconstruct the dose on heterogeneous phantoms. Phantoms are numerical representations of the human body, used to simulate the effects of radiations on the organism.

Among the faster calculation procedures, some calculation procedures consider implicitly that there is electronic equilibrium over the whole of the phantom. Electronic equilibrium is achieved in an infinitesimal volume of a material, when there are as many electrons entering the volume and depositing their energy therein, as electrons leaving it. Such is for example the case for procedures described by Wong J. & Purdy J. in 1990 in ‘On methods of inhomogeneity corrections for photon transport’, Med. Phys. 17, 807-14, in the AAPM document of 2004: Tissue inhomogeneity corrections for megavoltage photon beams, AAPM Report No 85 (College Park, Md.: AAPM). These procedures propose a mapping between a point of a heterogeneous dose profile and a point situated at the same radiological depth in a homogeneous dose profile, that is to say a point where the fluence of the two beams is the same. However, this procedure is much too inaccurate at the interfaces between different materials, since it does not manage the electron flux differences at the interfaces.

Another procedure, termed the Clarkson procedure, is notably described by Clarkson, J. in 1941 in ‘A note on depth doses in fields of irregular shape’, Brit. J. Radiol. 14, 265-8 and by Cunningham J. R. in 1972 in, ‘Scatter-air ratios’, Phys. Med. Biol. 17, 42-51. In Clarkson's procedure, the dose calculations are performed at two levels, that of the primary dose and that of the secondary dose. A primary dose may be defined as a dose deposited by a first interaction for example of photons making up the beam of particles with matter, and then by the electrons arising from the first interaction. A secondary dose may be defined as a dose deposited by secondary photons via their interaction with matter or the interaction with matter of the electrons that they have produced. A photon is termed secondary if it does not make up the initial beam but has been produced following an interaction of another photon or of an electron with matter, which are themselves able to make up the initial beam or result from a cascade of interactions which is initiated by a first interaction of a photon of the initial beam with matter. By slicing the cross section of a wide beam into triangular sectors, this procedure reconstructs the dose by adding together the contributions of each sector. It is thereafter possible to adapt Clarkson's procedure in the case of a beam profile having a heterogeneous fluence. A heterogeneous fluence may be obtained by a wedge filter for example. Clarkson's procedure also consists in this case in slicing the beam into angular sectors. Finally, heterogeneous phantoms may also be treated by taking into account the materials crossed by the beam, sliced into sectors and into sub-sectors, and then those crossed by the secondary particles. These various adaptations add great complexity to the calculations while not guaranteeing good accuracy.

So-called convolution and/or superposition procedures are notably described by: Mackie T. R., Scrimger J. W. & Battista J. J. in 1985 in ‘A convolution method of calculating dose for 15-MV x rays’, Med. Phys. 12, 188-96; Ahnesjö A. in 1989 in ‘Collapsed cone convolution of radiant energy for photon dose calculation in heterogeneous media’, Med. Phys. 16, 577-92; Tillikainen L., Helminen H., Torsti T., Siljamaki S., Alakuijala J., Pyyry J. & Ulmer, W. in 2008 in ‘A 3D pencil-beam-based superposition algorithm for photon dose calculation in heterogeneous media’, Phys. Med. Biol. 53, 3821-39. A conventional approach, termed “point kernel”, uses energy-deposition kernels. Energy-deposition kernels give a spread of the secondary dose around a point of interaction of primary photons. The kernels are pre-calculated via Monte Carlo simulations. Thus the three-dimensional dose may be obtained by convolving such a kernel with an interaction density for the primary photons. The interaction density for the primary photons may be obtained by a depthwise plot of the beam. However, this convolution requiring an appreciable calculation time, various accelerations have been proposed. One such is the so-called “collapsed cone convolution” procedure, described by Ahnesjö. The “collapsed cone convolution” procedure consists in modeling kernels in the form of exponential functions. Such a modeling enables an accelerated scheme for the convolution calculation. However, despite the acceleration of the calculations, they last of the order of a minute, this not being suited to the desired conditions of use. Another conventional approach for accelerating the convolution of the “point kernel” procedure is dubbed “pencil beam”. The “pencil beam” procedure, described by Tillikainen, consists in pre-integrating the kernels along a vertical axis to form the dose deposited by a beam of infinitesimal cross section. The reconstruction of the dose for a complete beam then consists in using a convolution of the “pencil beam” kernel with a profile of input fluences of the complete beam. Corrections made to this procedure make it possible to obtain an appropriate accuracy of the calculation of doses at the level of the interfaces between two different materials. However, the calculation times still remain of the order of a minute.

Various authors have proposed the use of artificial neural networks to learn dose profiles in homogeneous materials so as to reproduce them for heterogeneous materials. Among the procedures using neural networks, a procedure is described by Vasseur A., Makovicka L., Martin E., Sauget M., Contassot-Vivier S. & Bahi J. in 2008 in ‘Dose calculations using artificial neural networks: A feasibility study for photon beams’, Nucl. Instr. and Meth. In Phys. Res. B 266, 1085-93. Given that it is not conceivable, because of the complexity of the problem, to use the capabilities of generalization of neural networks so that they directly reproduce the dose in a heterogeneous medium, Vasseur has proposed that neural networks be coupled with techniques for adjusting the dose at the interfaces. A heterogeneous medium is a medium composed of several different materials. Thus semi-physical models have been constructed. However, on account of the assumptions of electronic continuity at the interfaces between different materials, the procedures described by Vasseur cannot correctly model the narrow beams of IMRT. An improvement to this procedure is proposed by B. Blanpain, D. Mercier, J. Barthe, in the document “Calcul par réseaux de neurones de la dose déposée en radiothérapie par un faisceau fin dans un volume hétérogene” [Calculation by neural networks of the dose deposited in radiotherapy by a slender beam in a heterogeneous volume], Actes de la manifestation des jeunes chercheurs en sciences et technologies de I'information et de la communication [Proceedings of the work of young researchers in information and communication sciences and technologies] MaJeSTIC 2007, Caen, Oct. 29-31, 2007. The proposed improvement is an extension of the procedures using neural networks, to narrow beams, for which there is no lateral electronic equilibrium, thereby giving rise to appreciable discontinuities at the level of the interfaces between different materials. However, such procedures are not sufficiently accurate or rapid for the intended application.

An aim of the invention is notably to very rapidly calculate the dose deposited in the patient by an irradiation protocol, while being accurate enough not to endanger the patient. For this purpose, the subject of the invention is a method for calculating doses deposited by at least one beam of ionizing particles on voxels of a phantom of a patient. The phantom may be meshed. Each mesh cell of the phantom can comprise voxels of one and the same material. The calculation method can comprise at least the following steps for each beam:
a first step of calculating at least one analytical function for apportioning doses deposited by the first beam for example for each mesh cell of a set of mesh cells of the phantom;
a second step of calculating doses on several voxels of the mesh, the value of the dose for a voxel being notably the value of the analytical function for apportioning doses of the mesh cell to which the voxel belongs, at the position of the voxel in the mesh cell.

The first step can comprise:
a first calculation of analytical functions for first mesh cells of the phantom that are crossed by the first beam, the analytical functions thus obtained may be pillar models;
a second calculation of analytical functions for second mesh cells of the phantom, that are not crossed by the first beam, for example by scattering of the pillar models, by traversing notably gradually the second mesh cells of the phantom, starting from the mesh cells crossed by the first beam, so as to obtain scattering models for example for the mesh cells of the set of mesh cells which are not crossed by the first beam.

The set of mesh cells of the phantom comprises mesh cells for each of which for example at least one of the values of the analytical function on the mesh cell is greater than a given threshold.

An analytical function may be composed of at least two functions:
a first projection function associating for example a first position p of a mesh cell with a second position p′ in a phantom for example of a homogeneous material, said homogeneous material having characteristics similar to the characteristics of the material of the voxels of the mesh cell;
a second model function associating for example with the second position p′ in the phantom of the homogeneous material a dose being deposited thereat by a second beam similar to the first beam.

A scattering model may be composed of three functions:
the first projection function;
the second model function;
a third validity function associating for example with a third position in one of the second mesh cells, a degree of weighting applied to the second model function.

A calculation of analytical functions for apportioning doses may be performed for two adjacent mesh cells of various materials, the second interface between the two mesh cells possibly being crossed in an oblique manner by the first beam, by using for example a decomposition of the first beam into several sub-beams. It being possible for the calculation of analytical functions to be performed for each sub-beam in the same manner as for a beam. It is also possible not to use any decomposition of the beam or to apply different deforming projections ensuring continuity of the fluence at the interfaces.

A calculation of analytical functions for apportioning doses deposited by the first beam may be performed for two adjacent mesh cells of various materials, the first beam propagating for example in a manner substantially parallel to the first interface. The calculation of analytical functions can comprise a calculation of an analytical function per sub-beam. The first beam may be decomposed into several sub-beams. The calculation of analytical functions may be performed for each sub-beam in the same manner as for a beam.

An analytical function for apportioning doses deposited by the first beam may be obtained through a weighted sum of the analytical functions associated with each sub-beam of the first beam, said weighting depending on a first position p of a mesh cell.

The weighting may be deduced from a normalization of first coefficients arising from a Gaussian shape function.

The weighting may be deduced from a normalization of second coefficients arising from a function of the shape of a Bell function.

Corrective elements may be applied to an analytical function for apportioning doses for a fifth mesh cell, of different material relative to a sixth mesh cell adjacent to the fifth mesh cell, said corrective elements being able to model an electronic discontinuity in proximity to a third interface between the fifth mesh cell and the adjacent sixth mesh cell.

The corrective elements may be based on “shutdown” models, signifying literally stopping models.

Corrective elements for a mesh cell are based on a weighted sum of the analytical functions of the mesh cell and of the analytical functions of the mesh cells adjacent to the mesh cell, said weighting depending on a first position p in the mesh cell.

The dose' deposited by a beam in the phantom of homogeneous material is given by a base model pre-calculated by using a dose distribution obtained by a simulation according to a Monte Carlo procedure.

The principal advantage of the invention is notably to obtain a much reduced dose calculation time for a set of points of a phantom.

Other characteristics and advantages of the invention will become apparent with the help of the description which follows, given by way of nonlimiting illustration and with regard to the appended drawings which represent:

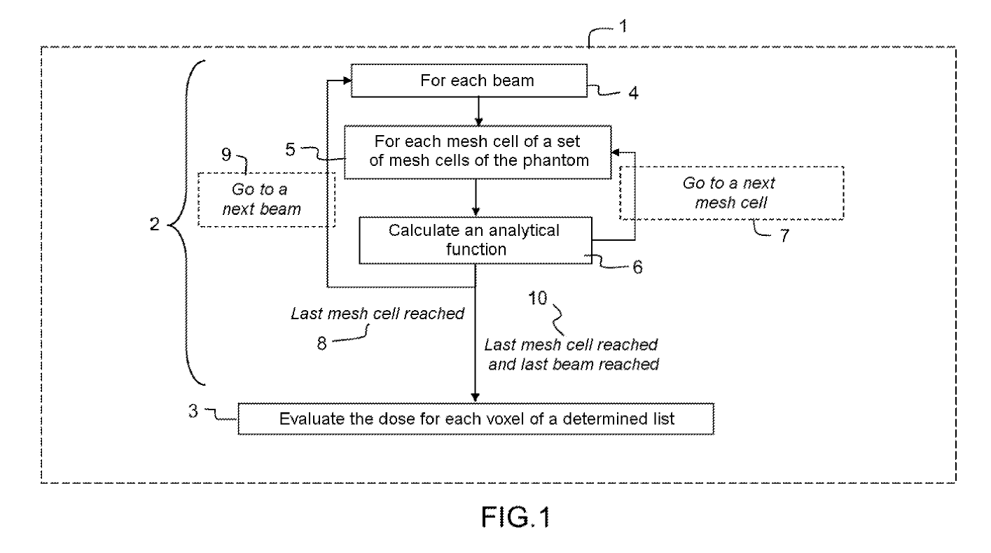

FIG. 1: a flowchart of the main steps of the method according to the invention;

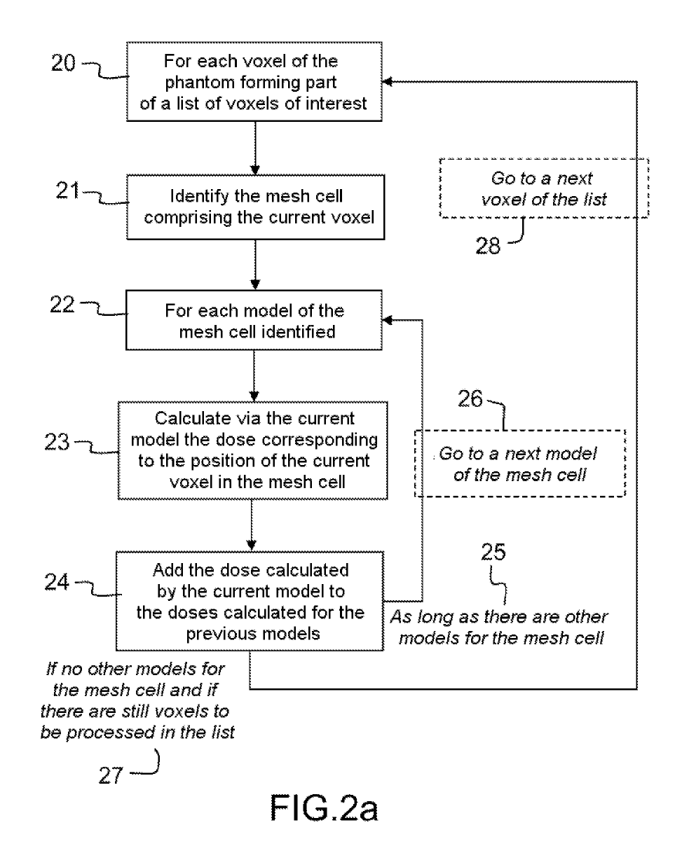

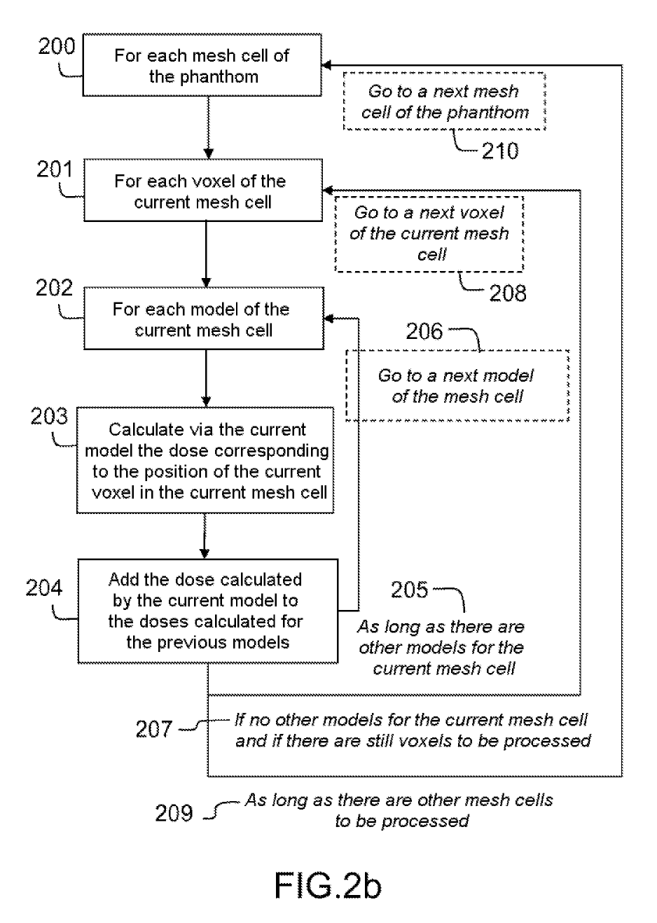

FIG. 2a: a first example of a calculation of doses on points of the phantom;

FIG. 2b: a second example of a calculation of doses on points of the phantom;

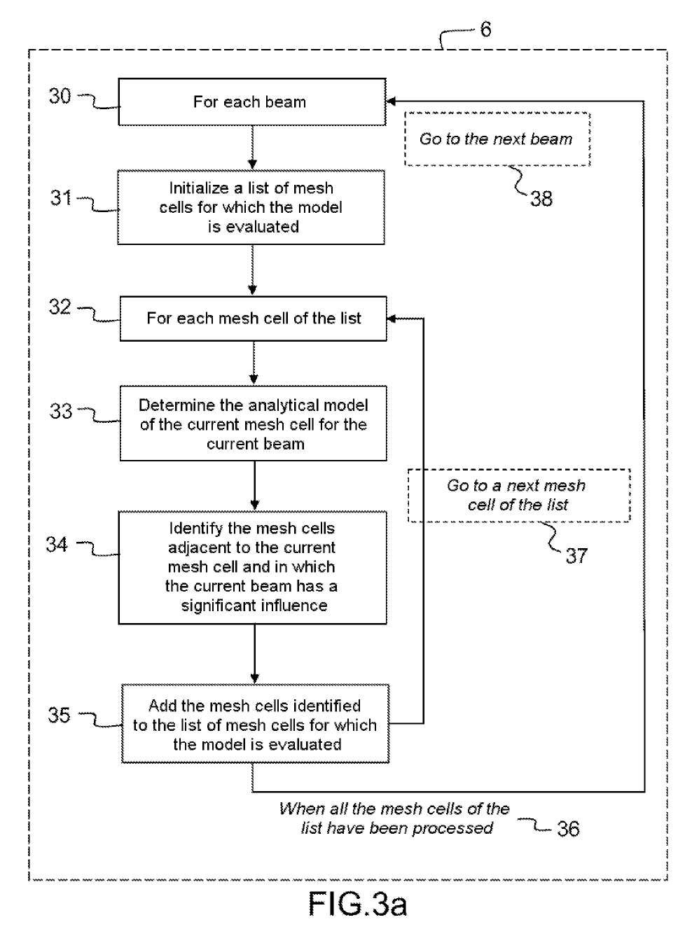

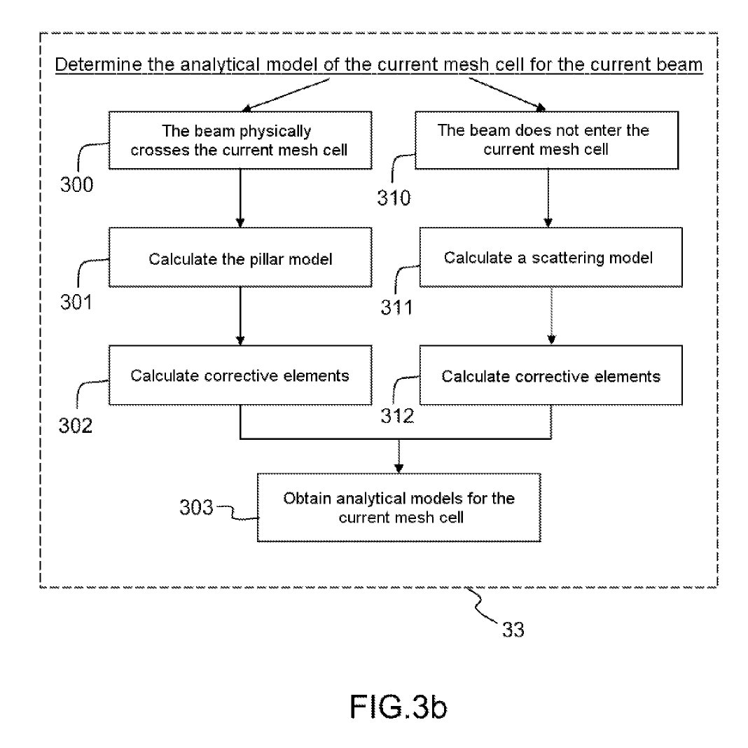

FIG. 3a: several possible steps of a calculation of the analytical functions for the mesh cells of a phantom;

FIG. 3b: several possible steps of a calculation of an analytical function for a given mesh cell and a given beam;

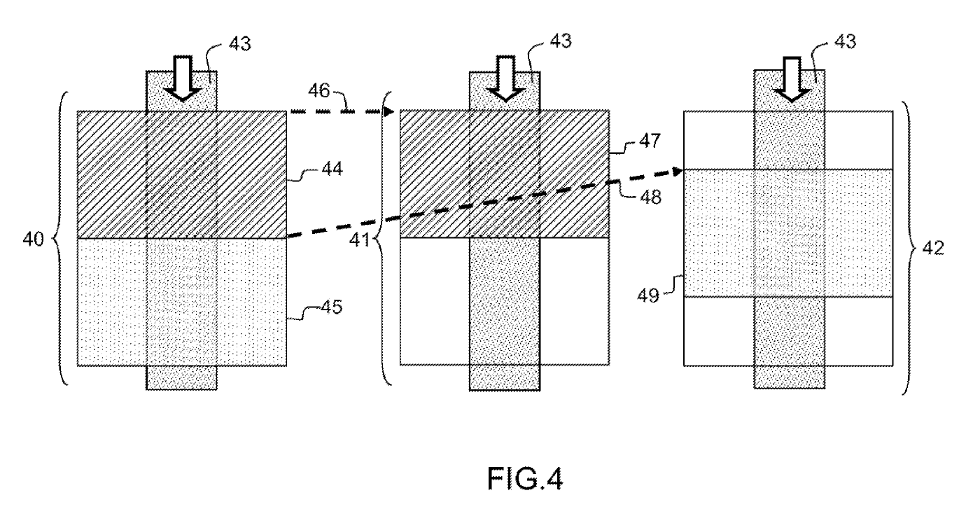

FIG. 4: an example of a procedure for projecting a model in a homogeneous medium onto a heterogeneous medium;

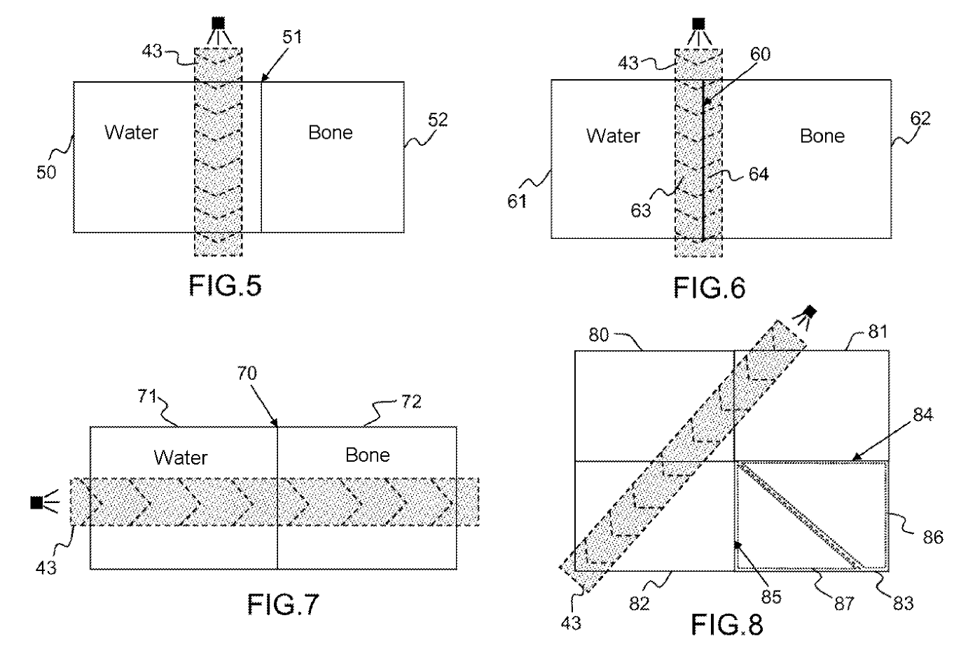

FIG. 5: a beam crossing a homogeneous material mesh cell;

FIG. 6: a beam positioned on an interface between two mesh cells comprising two different materials;

FIG. 7: a beam crossing two mesh cells comprising two different materials, in a manner substantially orthogonal to the interface between the two materials;

FIG. 8: a beam crossing mesh cells obliquely.

FIG. 1 represents several general steps of the method for calculating doses of ionizing radiations, deposited by at least one beam of particles. Such a beam of particles may be used by a device for the therapeutic treatment of a cancer. The calculation method according to the invention can notably be implemented by a radiotherapy treatment planning system. Such a system can notably be used by an oncologist doctor in the course of a consultation so as to establish a therapeutic treatment protocol using radiotherapy.

The principle of treatment by ionizing radiations is to destroy a tumor by using one or more beams of particles simultaneously such as photons, electrons, hadrons.

Within the framework of the embodiment presented by way of example, the beams of particles are narrow beams of photons of constant cross section and with a homogeneous fluence. However, the present invention is not limited to such beams, the invention may be applied to heterogeneous and divergent beams.

The principal role of the photons is to set electrons into motion, said electrons are responsible for the major part of the ionizations and of the dose deposition. This is why photons are termed indirectly ionizing, and electrons directly ionizing.

A physical quantity used to characterize a beam of photons is the fluence. Fluence is defined by the number of photons crossing a unit surface area. The fluence φ₀ of a beam of photons penetrating a homogeneous material is attenuated according to an exponential law. At a depth z in the material penetrated by the beam, the fluence in photons not yet having interacted is given by the following relation:

φ_{z}=φ₀θ^{-μz} (1000)

The coefficient μ is called the lineal attenuation coefficient. It is proportional to the electron density of the material, that is to say to the number of electrons per unit volume, and also varies with the energy of the photon.

The ionized atoms release electrons which cause other ionizations on their journey, before stopping when they have lost all their energy. In contradistinction to photons, electrons interact continuously with matter, thus losing their energy very rapidly. Their journey is of bounded length, whereas a photon has a nonzero probability of crossing any thickness of matter.

A quantity of interest used to quantify depositions of energy by ionizing radiations is the dose D. The dose D is a local quantity equal to the deposited energy, relative to the mass m. This deposited energy is the difference between the energy which enters a small volume of mass dm, and that which re-emerges therefrom: dE.

Hence,

D=dE/dm (1001)

The calculation method according to the invention uses notably a phantom of a patient, that is to say a three-dimensional matrix representation of a part of the patient's body. In a phantom, each voxel is characterized by a material and/or an electron density. The phantom of the patient is thereafter meshed. A mesh cell corresponds to a grouping of adjacent voxels. All the voxels of one and the same mesh cell relate notably to one and the same material and to one and the same electron density. The mesh may be regular or irregular, the mesh cells possibly having variable dimensions and variable shapes. In the subsequent description and by way of example, the mesh used comprises mesh cells of rectangular-parallelepiped shape.

The method according to the invention also uses base models of dose deposition in homogeneous materials. A base model of dose deposition can exist for each homogeneous medium, that is to say for each material making up the human body. Moreover, a model of a first medium that is not available may be deduced from a model of a second medium, that is close in terms of electron density to the first medium. The model relating to the second medium may be obtained by an operation of compression or expansion of the model of the first medium. The compression or expansion operation is called a scaling. A base model may be obtained with the aid of a dose distribution obtained in a known manner by a procedure of Monte Carlo type for example, by parametrization of a regression tool. The parametrization step is sometimes also called a learning step. Such a regression tool can use a neural network, a spline function, a support vector regressor commonly dubbed SVR for support vector regression, or an interpolator in a table of values. The base models are notably defined for the same conditions: a beam always with one and the same cross section, one and the same unit fluence, one and the same energy spectral distribution, arriving from the vacuum, in a substantially orthogonal manner, onto a half-space containing the material considered. It is also possible to define base models for beams of different cross sections, of different spectral distribution, or of other variations of experimental conditions, by producing as many models per materials as there exist cases to be taken into account.

In FIG. 1 are represented two main steps 2, 3 of the method for calculating doses 1 according to the invention.

A first main step 2 of the method for calculating doses 1 may be a step of calculating an analytical formulation of a spread of dose for each of the mesh cells of a set of mesh cells of the phantom and for each of the beams. The global beam may be decomposed into several beams or sub-beams, of different fluences for example, several beams can irradiate the tumor at the same time. The set of mesh cells is specific to each beam or sub-beam. The set of mesh cells corresponds to the mesh cells irradiated by the beam or sub-beam. The analytical formulation may be an analytical function or model of dose spread making it possible to directly calculate the dose deposited notably by a given beam at any point of a given mesh cell. Hereinafter, for the analytical formulation of dose spread, the terms analytical function or analytical model are employed interchangeably. Each mesh cell of the set of mesh cells can therefore be associated with one or more analytical models according to the number of beams or sub-beams interacting with the material of the mesh cell. An analytical model, or function, corresponding to a beam takes as parameter a position of a point in the mesh cell and provides as output the dose deposited by the beam at this point of the mesh cell. The first main step 2 can therefore, for example, comprise the following processing operations: for each beam 4, and for each mesh cell of the set of mesh cells 5, an analytical function is calculated 6. Once the determination of an analytical function for a mesh cell has been performed, we go to a next mesh cell 7 in the set of mesh cells that is specific to the beam and we calculate an analytical function relating to the next mesh cell. Once all the mesh cells of the set of mesh cells have been traversed, that is to say the last mesh cell of the set of mesh cells is reached 8, the algorithm passes to a next beam or sub-beam 9. Once all the beams have been traversed, that is to say the last mesh cell of the set of mesh cells of the last beam has been processed 10, we go to the second main step 3 of evaluating the dose for each voxel of a predetermined list of voxels. The list of voxels can, for example, contain the set of voxels of the phantom or only certain voxels exhibiting particular interest from the medical point of view for example. If no analytical model is associated with a mesh cell, the dose deposited in each voxel of this mesh cell is considered to be zero.

FIGS. 2a and 2b represent examples of possible steps for evaluating the dose 3 at points of the phantom, such as is represented in FIG. 1. According to the principle of superposition of doses, a dose deposited in a particular position of the phantom is the sum of the doses deposited by each beam or sub-beam. Each beam or sub-beam corresponds to an analytical model for each mesh cell of the phantom.

FIG. 2a represents possible steps of calculating the dose at various points of the phantom, each point being represented by a voxel. FIG. 2a particularly represents a calculation of the dose for a predefined list of voxels of interest. For each voxel of the list 20 of voxels of interest, this entails identifying the mesh cell of the phantom 21 to which a voxel undergoing treatment in the list, the current voxel, belongs. Thereafter, for each analytical model associated with the mesh cell identified 22, the value of the dose is calculated for the current voxel 23. The value of the dose calculated is thereafter added to the values of the doses calculated by the analytical models used previously for the current voxel 24. As long as there exist analytical models that are not used to calculate the dose at the current voxel of the identified mesh cell 25, the calculation of the dose is repeated by going to a next model 26 for the identified mesh cell and by a calculation of the dose by the next model, following the current model 23. Thereafter the new dose obtained by the next model is added 24 to the doses obtained previously for the current voxel. Thereafter, when the dose has been calculated for each analytical model of the mesh cell identified for the current voxel 27, the same calculation is effected for a voxel following the current voxel 28 in the list of voxels of interest 20, doing so until the dose has been calculated for all the voxels of the list of interest.

FIG. 2b represents other possible steps of calculating the dose at various points of the phantom. The steps represented in FIG. 2b may be implemented when the dose is calculated at any point of the phantom or in a regular manner as for example every n points, n being an integer greater than one for example. The steps represented in FIG. 2b have the advantage, in this case, of making the calculation of the dose faster because there is no need to identify the mesh cell comprising the current voxel. For each mesh cell of the phantom 200, for each voxel of a mesh cell undergoing processing of the phantom 201, or for each nth voxel of the current mesh cell, for each model associated with the current mesh cell 202, the calculation of the dose corresponding to the position of the current voxel in the current mesh cell is performed by the current model 203. Thereafter the dose calculated by the current model is added to the dose calculated by the previous models for the current voxel, in the current mesh cell 204. As long as there exist models, associated with the current mesh cell 205, by which the dose at the current voxel has not been calculated, a next model of the mesh cell becomes the current model 206 and the calculation of the dose 203 is performed and then added to the doses previously calculated for the current voxel of the current mesh cell 204. And so on and so forth until all the models of the current mesh cell have calculated their contribution to the dose of the current voxel. Thereafter, if there are still voxels to be processed 207, a next voxel becomes the current voxel 208 and the models of the current mesh cell calculate the dose at the position of the current voxel as described previously. Thereafter, when the dose has been calculated for all the voxels or all the n voxels of the current mesh cell and there are still mesh cells of the phantom for which the doses have not been calculated 209, the doses are calculated for the voxels of the next mesh cell, which then becomes the current mesh cell 210. Thus the doses are calculated for each voxel of the phantom, or for each nth voxel of the phantom.

Advantageously, the calculation of the dose on each voxel is reduced to the estimation of an analytical formula thus making this calculation very fast. Moreover as the algorithm makes it possible to calculate the dose solely at points for which it is necessary, the calculation time depends on the number of voxels selected. Advantageously the smaller the number of voxels, the faster the calculation. This therefore makes it possible to adapt the calculation time to contexts of use of the method according to the invention depending on whether more or less time is available to obtain a utilizable result.

FIGS. 3a and 3b represent steps of the determination of an analytical formulation for each mesh cell and each beam 6 such as is represented in FIG. 1. The determination of an analytical formulation for each mesh cell and each beam is an iterative process represented in FIG. 3a: Thus for each beam 30, a list of mesh cells for which the model is evaluated 31, is initialized. The mesh cells of the initial list are the mesh cells by which the current beam enters the phantom. With the mesh cells of the list is associated information about each beam which cross them such as the orientation of the beam, the fluence of the beam, as well as information regarding neutral propagation. The information regarding neutral propagation conveys the fact that the beam has not crossed any material before it penetrates the mesh cell. The information regarding neutral propagation also conveys the fact that the dose on the outside surface of the mesh cell is zero since it may be supposed that outside the phantom, the beam crosses the vacuum. As long as the list of mesh cells for which the model is calculated is not empty, for each mesh cell of the list 32, the analytical model of the current mesh cell for the current beam is determined 33. The determination of the analytical model of the current mesh cell for the current beam 33 is based notably:
on characteristics of the current beam with which the model is associated;
on characteristics relating to the propagation of the current beam in the current mesh cell.

Thereafter, the mesh cells adjacent to the current mesh cell and in which the current beam has a significant influence 34, are identified and added to the list of the mesh cells for which an analytical model is evaluated 35. The significant influence of the current beam in a current mesh cell may be characterized by a given threshold value for at least one of the values of the analytical function on the current mesh cell. The identification of the mesh cells adjacent to the current mesh cell and in which the effects of the beam must be propagated, is performed in the direction of propagation of the beam and as a function of the value of the dose calculated at the interface between the current mesh cell and each mesh cell adjacent to the current mesh cell. If the value of the dose on an interface between the current mesh cell and an adjacent mesh cell may be considered to be negligible at all points of the interface, the dose is then considered to be negligible in the adjacent mesh cell in question. The mesh cells for which the dose is considered to be negligible are therefore not added to the list of mesh cells. The mesh cells added to the list of mesh cells are associated with parameters of the beam as well as with propagation parameters of the beam. Each mesh cell of the list of mesh cells for which the model is evaluated are processed in turn 37 until the list of mesh cells is empty. When all the mesh cells of the list have been processed 36, the next beam or sub-beam is processed, if there is one. The next sub-beam becomes the current sub-beam 38 and the processing recommences with the initialization of a list of mesh cells for which the model must be evaluated 31, for the current beam.

FIG. 3b represents various steps of the determination 33 of the analytical model of the current mesh cell for the current beam. To determine the analytical model relating to a mesh cell for a given beam, two cases may be distinguished:
a first case 300 for which the current beam, or a part of the current beam, physically crosses the current mesh cell;
a second case 310 for which the current beam does not cross the current mesh cell.

In the first case where the current beam, or a part of the current beam, physically crosses the mesh cell, the analytical model may be determined in two stages.

In a first stage, a pillar model is calculated 301. A pillar model represents the dose deposited in the current mesh cell assuming that the mesh cells adjacent to the current mesh cell have the same composition as the current mesh cell itself. The pillar model is notably the model which, in a mesh cell has, in general, the most influence on the calculation of the dose at any point of the mesh cell. The pillar model may be defined with the aid of a model of dose deposition in a homogeneous material. The model of dose deposition in a homogeneous material is also called a homogeneous-medium model or base model. A homogeneous-medium model corresponds to experimental conditions described previously. The beam arrives at the material in a manner substantially orthogonal to the material, from the vacuum, on a half-space containing the material considered. Moreover the beam is of unit fluence.

The pillar model is obtained by projection of the homogeneous-medium model. The projection is performed via a formula which associates with a first given position p of the current mesh cell a second position p′ in a homogeneous material such that: the dose deposited at each first position p in the current mesh cell, under the assumption that the adjacent mesh cells have the same composition as the current mesh cell, is equal to the product of the fluence of the beam times the dose deposited in a homogeneous medium at the associated second position p′.

If only part of the beam crosses the current mesh cell, a corrective factor, related to the proportion of the signal crossing the mesh cell and to geometric considerations, is applied to the pillar model.

In a second stage, first corrective elements 302 of the pillar model may be calculated. The first corrective elements make it possible to take account of electronic disequilibria caused by a change, if any, of material at the interfaces between the adjacent mesh cells. The first corrective elements take into account the pillar model of the current mesh cell but also the pillar model of a mesh cell adjacent to the current mesh cell, situated upstream of the current mesh cell with respect to the direction of propagation of the beam, and optionally the pillar model of a mesh cell adjacent to the current mesh cell situated downstream of the current mesh cell with respect to the direction of propagation of the beam. The consideration of the pillar model of a mesh cell situated downstream is useful so as to take account of a phenomenon of backscattering of the beam. The corrective element is described in greater detail subsequently. The corrective element can take various forms such as an additive model or weightings applied to the various pillar models.

In the second case, the beam does not re-enter the current mesh cell 310. The dose deposited then stems only from the phenomenon of scattering of the electrons and secondary photons in the material. In this case, the analytical model of the mesh cell is a model resulting from an operation of scattering 311 of the pillar models defined for the mesh cells close to the current mesh cell. The model thus obtained may be dubbed a scattering model. Pillar models of different mesh cells do not influence the analytical model of the current mesh cell in the same zones. The scattering of a pillar model of an adjacent mesh cell is performed by defining a zone of validity of the scattering model in the current mesh cell or by defining weights assigned to the scattering models, said weights depending on the position in the mesh cell and being equal to zero wherever the scattering model is not valid. In this case, there is no pillar model over the whole of the current mesh cell. Second corrective elements can thereafter be determined 312. The second corrective elements have the same physical origins and are similar in their forms to the first corrective elements 302.

Advantageously, if the phantom is segmented into mesh cells of appreciable sizes, the step, represented in FIG. 3a, of calculating the analytical model for each mesh cell 33, is very fast. In particular the calculation time for the pillar models 301, for the scattering models 311, or for the first and second corrective elements 302, 312 are identical for two phantoms having one and the same mesh but one of which comprises twice as many voxels in each direction as the other phantom.

FIG. 4 illustrates the principle of the projection to a homogeneous model to obtain analytical models for each of the two mesh cells 44, 45, of a heterogeneous phantom 40. The heterogeneous phantom 40 comprises two different materials. A first mesh cell 44 of the heterogeneous phantom comprises a first homogeneous material, for example water. A second mesh cell 45 comprises a second homogeneous material, for example bone. FIG. 4 represents a beam 43 penetrating the heterogeneous phantom 40 through the first mesh cell 44. FIG. 4 also represents the same beam, 43 penetrating a first homogeneous phantom comprising a third homogeneous material 41 composed of water, that is to say composed of the same material as the first mesh cell 44. FIG. 4 also represents the beam 43 penetrating a second homogeneous phantom comprising a fourth homogeneous material 42 composed of bone, that is to say composed of the same material as the second mesh cell 45. The pillar models used for the mesh cells 44, 45 may be compositions of two functions:
a first projection function which associates with the first three-dimensional position p in a mesh cell 44, 45, the second position p′ in a homogeneous phantom 41, 42 whose material possesses the same characteristics as the material of the mesh cell 44, 45;
a second model function which associates with the second position p′ in the homogeneous phantom 41, 42, the dose which is deposited thereat by a beam 43 identical to the beam 43 entering the mesh cell 44, 45 but of unit fluence.

Therefore for each material of each mesh cell 44, 45, a projection 46, 48 from the space of the positions of the mesh cell 44, 45 to a space 47, 49 of positions of a homogeneous phantom of corresponding material, subjected to the same beam 43, is defined. For example, a first projection 46 starts from a first space of positions of the first mesh cell 44 to a second space of positions 47 in a first phantom of homogeneous material 41. The material of the first mesh cell 44 is of the same type as the material of the first homogeneous phantom 41. A second projection 48 starts from a third space of positions of the second mesh cell 45 to a fourth space of positions 49 in a second phantom of homogeneous material 42. The material of the second mesh cell 45 is of the same type as the material of the second homogeneous phantom 42. The dose deposited in a heterogeneous phantom 40 is therefore calculated with the aid of an equivalent or corresponding position in a homogeneous phantom 41, 42 irradiated by the same beam 43.

The two functions may be obtained in the following manner:
the first projection function depends on the parameters of the beam 43, such as the position, the orientation, the propagation parameters of the beam;
the model of doses deposited in the homogeneous phantom 41, 42 of the same material as the mesh cell 44, 45 is pre-parametrized, so as to be available immediately during the method for calculating doses according to the invention: to this end distributions of doses in three dimensions for the beam of interest 43, in various materials making up the phantom 40 of the patient, are pre-calculated and then used for the learning of the dose models before implementing the method according to the invention.

The pre-calculated distributions of doses may be generated for example by a Monte Carlo procedure. The regression tools used for the dose model may be for example neural networks, spline functions, support vector regressors, interpolators between the values of a table. The pre-calculated distributions of doses may be generated in other ways for example by performing an interpolation of values pertaining to real data. Other modes of generation can also be envisaged, an important criterion being the quality of the data making it possible to rely on realistic dose distributions.

Advantageously, the major part of the calculations related to physical equations for the transport of particles and for the interaction between radiation and matter is integrated into the base models.

The projections 46, 48 may be linear functions transforming coordinates in three dimensions in a first three-dimensional space, into coordinates in three dimensions in a second three-dimensional space.

Let f be a projection function for a mesh cell. Let m be a position, tied to the mesh cell, of the first space in three dimensions. The position m may be represented by a column vector with four elements. The fourth element conventionally equals one, and makes it possible to define a set of similarities, that is to say rotations, homotheties, translations or any composition of these transformations, by a matrix.

$$m = ( \begin{matrix}x \\ y \\ z \\ 1\end{matrix} ) \qquad ( 1002 )$$

Let r be the position in the reference frame of the homogeneous phantom, r is represented by a column vector with three elements. The reference frame of the homogeneous phantom may be oriented in such a way that the third component of the vector r is oriented along an axis in the direction of propagation of the beam in the homogeneous phantom. The third component of the vector r then corresponds to a depth of penetration of the beam in the homogeneous phantom.

$$r = ( \begin{matrix}{x}^{′} \\ {y}^{′} \\ {z}^{′}\end{matrix} ) \qquad ( 1003 )$$

The linear projection function f may be defined by a matrix product. The projection matrix P, giving the projection, can be written in the following manner:

$$P = ( \begin{matrix}a & b & c & α \\ d & e & f & β \\ g & h & i & γ\end{matrix} ) \qquad ( 1004 )$$

The Latin letters a, b, c, d, e, f, g, h, i represent coefficients giving an orientation of the two reference frames with respect to one another. The Greek letters α, β, γ give the positions of the reference frames with respect to one another; it is therefore the expression for a shift of one reference frame with respect to the other.

The projection function f can then be written:

r=f(m)=Pm (1005)

The use of the projection function f to establish analytical models relating to the mesh cells is explained in the description of the following figure.

An alternative to the composition of a first projection function and of a second model function so as to determine analytical functions may be to approximate the dose directly through a combination of an exponential function for the depth profile and of a bell-shape function for the lateral profile. The parameter of the exponential function depends solely on the material crossed and the parameters of the bell function depend on the material crossed and on the size of the beam. There is then no longer any projection since simple distance calculations suffice: distance between the first position p and the plane orthogonal to the beam, crossing the point of entry into the current mesh cell of the axis of the current beam for the exponential function and distance between the first position p and the axis of the beam for the bell function. Other analytical functions can also be envisaged.

FIG. 5 represents the beam 43 crossing a third mesh cell 50 in a manner substantially parallel to a first interface 51 between the third mesh cell 50 and a fourth mesh cell 52. The whole of the beam 43 crosses the third mesh cell 50. A step prior to the determination of the analytical models for the mesh cells of the phantom of the patient and for the current beam 43 may be a calculation of the projection matrices for each mesh cell crossed by a beam as a function of the characteristics of the beam on each mesh cell. For example in the case represented in FIG. 5, characteristics of the beam 43 may be: a position of the beam 43, dimensions and a radiological depth already traversed by the beam 43. The radiological depth represents a thickness of water that an initial beam, identical to the beam 43, would have to be made to cross in order for the beam 43, on entry to the mesh cell, to have the same fluence as the initial beam, after the initial beam has crossed the thickness of water. The initial beam is the beam 43 taken at the exit of the irradiation head of an irradiation source. The principle of determining a pillar model as described previously is as follows: with a given position in a given mesh cell is associated a position in a dose distribution deposited by the same beam in a homogeneous phantom of the same material as that of the given mesh cell. The same homogeneous model and the same projection formula are used for the whole of the mesh cell. The principle of determining a pillar model such as described previously is applicable only if the beam or a part of the beam crosses the mesh cell considered, this being the case for the third mesh cell 50.

Let m and r be the positions in the mesh cell and in the homogeneous phantom respectively. The coefficients a, b, c, d, e, f, g, h, i and the shifts α, β, γ of the projection matrix P are determined as a function of geometric characteristics of the beam and of propagation characteristics of the beam.

The coefficients a, b, c, d, e, f, g, h, i are directly determined with the aid of an expression for the director trihedron of the beam 43 in the frame of reference of m, that is to say the frame of reference of the mesh cell. The frame of reference of the mesh cell may be identical to the frame of reference of the phantom of the patient. The director trihedron of the beam is the triplet of unit vectors which define the axes of the beam which are equivalent to the canonical directions for the homogeneous model. (a, b, c) can therefore be a first normed direction vector, expressed in the frame of reference of the mesh cell which corresponds to the direction of the first component of r. (d, e, t) may be a second normed direction vector expressed in the frame of reference of the mesh cell which corresponds to the direction of the second component of r. (g, h, i) may be a third normed direction vector expressed in the frame of reference of the mesh cell, corresponding to the direction of the third component of r which is according to the convention taken here the depth therefore the axis of propagation of the beam. The shifts α, β and γ are then calculated with the aid of a particular point for which m and r are simultaneously known. For example, when possible, a point can be taken lying exactly at the center of the beam and on a surface of entry of the beam into the mesh cell. Indeed, the point being at the core of the beam, its projection is such that the first two components of r are zero, thereby completely determining α and β. Moreover, it is possible to calculate the depth of this point in the homogeneous model with the aid of the depth that it has in the previous model. The depth is the same if the materials of the two mesh cells are similar and otherwise it is deduced through a product with the ratio of the electron densities of the two materials. The calculated depth then makes it possible to identify γ. The projection matrix P is thus completely determined.

FIG. 5 also makes it possible to illustrate the calculation of a scattering model for mesh cells in which a dose is deposited but which are not crossed by a beam, such as the fourth mesh cell 52. The scattering models are calculated only for the mesh cells whose dose deposited by the current beam is not considered to be negligible 34 and which consequently have been added to the list of mesh cells 35, such as is represented in FIG. 3a. The first interface 51 separates two different materials, for example water in the third mesh cell 50 and bone in the fourth mesh cell 52.

The beam 43 passes into the third mesh cell 50 composed of water. One seeks to calculate the dose in the fourth mesh cell 52 composed of bone. The dose deposited in the fourth mesh cell 52 results mainly from particles set into motion in the third mesh cell 50, scattering into the fourth mesh cell 52.

A scattering model may be a composition of three functions:
a third projection function which associates with a third position q in three dimensions in the fourth mesh cell 52, a fourth q′ in a homogeneous phantom;
a fourth model function which associates with the second position q′ in the homogeneous phantom, the dose which is deposited thereat by a beam 43 identical to the beam 43 entering the third mesh cell 50 but of unit fluence;
a fifth validity function which associates with the third position q a degree of validity weighting the fourth model function.

Another approach may be not to use a validity function and to work by combining the various scattering functions arriving in the mesh cell from a single beam, by using for example a maximum function, a mean function.

At least three different calculations may be implemented so as to determine the model of scattering of the fourth mesh cell 52 which is not crossed by the beam 43.

A first calculation can use a third homogeneous phantom crossed by the beam 43, of the same material as the material of the third mesh cell 50. The dose distribution in the third homogeneous phantom is used as fourth model function of the model of scattering of the fourth mesh cell 52. The distribution of doses in the third homogeneous phantom is used to calculate the analytical model giving the contribution to the dose deposited in the fourth mesh cell 52 by the effects of the beam in the third mesh cell 50. The function for projecting the model of scattering of the fourth mesh cell 52 to the third homogeneous phantom may be initialized as for a pillar model for the coefficients a, b, c, d, e, f, g, h, i of the projection matrix P. A first scaling is then performed so as to take into account the differences of propagation between the materials of the third homogeneous phantom and the material of the fourth mesh cell 52. The first scaling is lateral: it applies to the first two dimensions of r and therefore to the coefficients a, b, c, d, e, f of the projection matrix P. The first scaling may be carried out for example according to the ratio of the densities of the two materials. The continuity of the distribution of the dose at the level of the first interface 51 is ensured by a fitting of the coefficients α, β, γ. The fitting is done for example at a point of the first interface 51 for which the equivalent projection r is known, with the aid of the projection of the pillar model of the mesh cell 50.

A second calculation can use a fourth homogeneous phantom crossed by the beam 43, of the same material as the material of the fourth mesh cell 52. The dose distribution in the fourth homogeneous phantom is used as fourth model function of the model of scattering of the fourth mesh cell 52. The dose deposited in the fourth mesh cell 52 originates from particles whose trajectories were initiated in the third mesh cell 50 by interactions with photons of the beam 43 scattering in a lateral manner with respect to the beam 43. The dose deposited in the fourth mesh cell 52 can therefore be obtained by using a distribution of doses deposited by the beam 43 in the fourth homogeneous phantom. The model's projection function is initialized as for a pillar model, for the coefficients a, b, c, d, e, f, g, h, i of P. A second scaling is then performed. It applies to the third dimension of r and therefore to the coefficients g, h, i of the projection matrix P. The second scaling may be carried out for example according to a ratio of the densities of the two materials. The scaling makes it possible to take into account the deviations between the coefficients of lineal attenuation, corresponding to the decay of the dose deposited as a function of depth z. The coefficients α, β, γ are thereafter fitted by considering a point of the first interface 51 for which its projection r is calculated. This projection may be deduced from the projection of this point in the pillar model of the third mesh cell 50 according to the principle already seen of equivalent depth, directly related to the radiological depth, and of its extension to the notion of equivalent distance to the edge of the beam. The coefficients α, β, γ can therefore be adjusted so that the distance to the edge of the beam in the fourth homogeneous phantom is equal to the product of the distance to the edge of the beam in the previous model, therefore here of the third mesh cell 50, times the ratio of the electron densities. A weighting coefficient on the scattering model intervenes so as to ensure continuity of the distribution of the dose at the interface between the third and the fourth mesh cell 50, 52. The weighting coefficient may be determined for example with the aid of the value of the dose at a point of the first interface 51.

A third calculation can use either the dose distribution in the third homogeneous phantom or the fourth homogeneous phantom crossed by the beam 43. The model's projection function is fully calculated by solving a system for several points of the first interface 51, for which points, according to the principles already described in the two previous calculations as a function of the material taken as reference, the projections r have been determined subject to the condition of taking at least four different points, the matrix P can then be fully determined. In the case where it is the dose distribution in the fourth homogeneous phantom, that is to say in a medium homogeneous with the material of the current mesh cell, a weighting coefficient on the scattering model intervenes so as to ensure continuity of the distribution of the dose at the first interface 51 between the third and the fourth mesh cell 50, 52. The weighting coefficient may be determined for example with the aid of the dose value at a point of the interface.

FIG. 6 represents the beam 43 propagating on a second interface 60 between a fifth mesh cell 61 and a sixth mesh cell 62. The fifth mesh cell 61 can comprise a material composed of water and the sixth mesh cell can comprise a material composed of bone. The beam 43 propagates in a manner substantially parallel to the second interface 60 between two materials of differing composition. Thus one part of the beam 43 is situated in the fifth mesh cell 61 and another part of the beam 43 is situated in the sixth mesh cell 62. To treat this particular case, it is possible to consider the beam 43 as &beam composed of two sub-beams 63, 64. A first sub-beam 63 propagates in the fifth mesh cell 61 and a second sub-beam 64 propagates in the sixth mesh cell 62. For example, the complete beam 43 can have a cross section of 1×1 cm². The complete beam can thus be sliced into two adjacent sub-beams 63, 64 of cross section 0.5×1 cm² for example.

To obtain a distribution of the dose deposited by the beam at a point of a mesh cell, the contributions of the sub-beams making up the beam are summed. The contributions of the sub-beams take the form of pillar models or scattering models for complete beams. Said contributions comprise a weighting of the models, so as to take into account the fact that the sub-beams are merely parts of the complete beam. The weightings are based on a modeling of the lateral spreading of the dose deposited by each sub-beam. Said lateral spreading is centered on the associated sub-beam.

For example, if we consider a plane substantially orthogonal to the axis of the beam 43, the dose on the plane may be the sum of various models of deposition of doses H_{f}(p′_{f}) in a homogeneous medium, taken at positions p′_{f} equivalent to the positions p in the mesh cell of the heterogeneous phantom, said model of doses H_{f}(p′_{f}) being weighted by weights ω_{f} associated with each sub-beam f:

$$D ( p ) = {\sum }_{F}^{ } {D}_{f} ( p ) = {\sum }_{F}^{ } {H}_{f} ( {p}_{f}^{′} ) \cdot {ω}_{f} ( p ) \qquad ( 1006 )$$

where F represents the set of the sub-beams f constituting the beam at the depth considered. The sum of the weightings ω_{f} of each sub-beam f is set equal to one.

The weightings ω_{f} can for example be calculated with the aid of functions k_{f}(p) representing the spreading of the energy dissipated by the ionizing radiation originating from a sub-beam f, as a function of the deviation between the position p and the axis of the sub-beam f, according to the following formula:

$${ω}_{f} ( p ) = \frac{{k}_{f} ( p )}{{\sum }_{F}^{ } {k}_{f} ( p )} \qquad ( 1007 )$$

Formula (1007) is a normalization of the weights k_{f}(p). It should be noted that the weights are functions of space and therefore the weighting can vary according to the position p. Formula (1006) can therefore also be interpreted as the simple sum of the models of doses H_{f} modulated respectively by the functions ω_{f}.

The following relation is therefore obtained, f′ being a sub-beam belonging to the set of sub-beams F:

$$D ( p ) = {\sum }_{f ∈ F}^{ } \frac{{k}_{f} ( p )}{{\sum }_{f ∈ F}^{ } {k}_{f} ( p )} \cdot {H}_{f} ( {p}_{f}^{′} ) \qquad ( 1008 )$$

and therefore

$$D ( p ) = \frac{1}{{\sum }_{F}^{ } {k}_{f} ( p )} {\sum }_{F}^{ } {k}_{f} ( p ) \cdot {H}_{f} ( {p}_{f}^{′} ) \qquad ( 1009 )$$

A first exemplary function k_{f}(p) may be a Gaussian function equal to one at the center of the beam. By considering a sub-beam f as rectangular, by approximation if necessary, a covariance matrix Σ_{f} of the Gaussian may be defined so that these principal axes are those of the rectangle and the standard deviation in relation to these axes is the half-length of the side associated with the axis. The center of the Gaussian can correspond to the center of the sub-beam f. Thereafter, the Gaussian may be multiplied by the area of the sub-beam f at the depth considered.

Multiplication by the area of the sub-beam f at the depth considered, that is to say its cross section, makes it possible advantageously to represent the fact that the contribution of the sub-beam f is all the more appreciable the larger its cross section.

The following formula is then obtained for the function k_{f}(p):

$${k}_{f} ( p ) = {a}_{f} \cdot {e}^{- \frac{1}{2} {( p - {c}_{f} )}^{T} {\sum }_{f}^{- 1} ( p - {c}_{f} )} \qquad ( 1010 )$$

where a_{f} is the area of the cross section of the sub-beam f, Σ_{f} its covariance function and c_{f} its center.

The use of a Gaussian as weighting function is simple and advantageously avoids overloads in calculation time.

Another function k_{f}(p) may be used: this is the Bell function, the so-called bell curve. In three dimensions, the Bell function can take the following form:

$$B ( p ) = \frac{1}{1 + {( {( p - {c}_{f} )}^{T} {( {\sum }_{f} )}^{- 1} ( p - {c}_{f} ) )}^{b}} \qquad ( 1011 )$$

where b makes it possible to adjust the slope of the function. With respect to the slopes observed in the material, it is possible to set b to be the product of this slope times the determinant of Σ_{f} thereby giving the same slope on average. It is also possible to multiply the height of the dose profile desired by the area a_{f} of the cross section of the beam f. A function is then obtained which does indeed model the lateral separation of the dose distribution and notably, its center, its amplitude, that is to say the level of the dose at the center of the curve, the width of its plateau, and its outside slope.

All the functions k_{f}(p) are taken into account in the calculation of the weighting at a point of a mesh cell. This is so even for a sub-beam f whose scattering model has not been calculated since it was considered to be negligible in the current mesh cell.

It will be noted that in practice only the plane orthogonal to the axis of propagation of the beam concerns us. This is conceptualized in Σ_{f} by an infinite standard deviation in relation to this third axis, and therefore a zero eigenvalue in its inverse, which is the only quantity to be represented. In practice, it will advantageously be possible merely to project the quantity (p-c_{f}) onto the plane of interest and to consider a two-dimensional covariance matrix.

Another approach is for example to consider the beam 43 as complete in each of the fifth mesh cell 61 and sixth mesh cell 62. Thereafter a correction may be applied to the interface.

Another possibility is to employ models pre-calculated for all the dimensions of sub-beams and to add them together directly.

FIG. 7 represents a beam 43 crossing two mesh cells 71, 72 in a manner substantially orthogonal to a third interface 70 between the two mesh cells 71, 72. A seventh mesh cell 71 can comprise a medium composed for example of water whereas an eighth mesh cell 72 can comprise a different medium to the medium of the seventh mesh cell 71 composed for example of bone. The beam 43 therefore crosses two different media, and therefore two different materials. Several procedures may be used to calculate, for the case represented in FIG. 7, corrective elements 302, represented in FIG. 3b, for the pillar models of the seventh and eighth mesh cells 71, 72. The correction is not compulsory but it makes it possible to obtain more reliable results.

A first possible procedure is a procedure using a “shutdown”, signifying literally stopping. A “shutdown” is a model representing the dose deposited after an interface by particles set into motion before it.

In this procedure, as a first approximation, backscattering is neglected. This approximation is particularly effective when the two materials have close physical characteristics.

Generally, to calculate the dose deposited in the eighth mesh cell 72, after the third interface 70, we begin by performing the calculation of the pillar model. Thereafter, a corrective element is added to take into account an electron flux differential at the third interface 70. Thus the expression for the dose deposited in the eighth mesh cell 72 just after the third interface 70 depends on the nature of the material of the seventh mesh cell 71 and on the nature of the material of the eighth mesh cell 72. In this procedure, the corrective element corresponds to a shut down whose amplitude is defined at the third interface 70 as being equal to the difference between the dose deposited at the third interface 70 according to the pillar model of the eighth mesh cell 72 and the dose deposited at the third interface 70 according to the pillar model of the seventh mesh cell 71. Continuity of the dose on traversing the third interface 70 is thus ensured.

A first calculation of the corrective element is done with the aid of a first shutdown in a homogeneous material corresponding to the material of the seventh mesh cell 71. To incorporate that the shutdown is that of a material other than that of the eighth mesh cell 72, a deformation of this shutdown is applied. To effect this deformation, a reference vanishing point is considered which is situated upstream of the interface, for example 5 cm before, and at the center of the beam. For a point considered of the eighth mesh cell 72, its distance from the third interface 70 is calculated along the straight line which passes through said point and the vanishing point. The equivalent distance in the shutdown considered is then calculated. As in the case of scattering, the equivalent distance is obtained by multiplying by the ratio of the electron densities of the two materials. This distance is charted in the shutdown function, according to an identical straight line, with the aid of the reference interface: the third interface 71. The value of the deformed shutdown is then obtained. It is noted that the deformation parameters are different according to the direction considered of scattering of the particles and are such that the scaling is maximal in the direction of propagation of the beam 43 and zero all along the interface. In practice, as in the case of the scattering models, this deformation can correspond to a scaling and may be performed by a projection function.

A second calculation uses a second shutdown in a homogeneous material similar to that of the eighth mesh cell 72 so as to calculate the dose deposited after the third interface 70. This procedure independently considers each radial position in the eighth mesh cell 72. The depthwise spread of the second homogeneous shutdown is similar to the spread of a third shutdown on the heterogeneous media of the seventh and eighth mesh cell 71, 72. However, the second shutdown differs from the third shutdown in terms of width at the level of the third interface 70, since the third shutdown is initiated by the material of the seventh mesh cell 71 before the interface. Therefore, the flux responsible for the dose deposition does not stretch in the same way at the level of the interface. A first solution for adapting the second shutdown is to base said solution on an assumption of continuity at the interface by adapting the second shutdown so as to place it at the proper flux level at least at the level of the interface. The error involved is all the smaller as the dose decreases on moving away from the interface. The first solution takes into consideration independently the values of dose deposited at each radial position (x, y) of the third shutdown and to make the values of doses thus obtained continuous by multiplying them by a coefficient in such a way that they are equal to the values of the first shutdown at the level of the third interface 70. It is therefore possible to multiply the second shutdown at a position (x, y, z) by the following ratio:

$$\frac{{SD}_{11} ( x , y , z = 0 )}{{SD}_{22} ( x , y , z = 0 )} \qquad ( 1012 )$$

with SD₁₁(x, y, z=0) representing the value of the first shutdown at the position (x, y, 0) and SD₂₂(x, y, z=0) representing the value of the second shutdown at the position (x, y, 0), the z=0 signifying here that we are situated at the interface. This procedure may be used according to two approaches which have already been described previously. The first approach is based on a dose distribution in a homogeneous medium by considering the assumption of electronic equilibrium over the set of mesh, cells 71, 72. In this first approach a compensation is added to the distribution so as to account for real electron fluxes in the eighth mesh cell 72. A second approach is based solely on a dose distribution in a homogeneous medium corresponding to the material of the eighth mesh cell 72 to which is added the dose originating from the contribution of the particles coming from the seventh mesh cell 71.

Other calculation procedures may be employed as a use of the second shutdown by adjusting all its columns by continuity. A column of a shutdown represents the values of the shutdown which correspond to a radial position (x, y). It is also possible to choose to use only one of the columns of the second shutdown, for example a central column, so as to save calculation time and memory space. To ensure continuity at the interface, it is possible to take a single continuity ratio on the axis of the beam 43 and to apply this same ratio to the second shutdown as a whole.

Another solution is to use the second shutdown in a complete manner and to adjust each of its columns to obtain continuity at the interface.

Another possible approach is a calculation by weighting of the pillar models of each mesh cell. The principal idea is to be able to go from the pillar model of the seventh mesh cell 71 situated before the third interface 70 to the pillar model of the eighth mesh cell 72 situated after the third interface 70 by a progressive transition based on weightings of each of the pillar models. To define the weightings, it is possible to use the following modeling of the physical phenomenon occurring at the interfaces: In a given mesh cell, if we are sufficiently far from an interface, in a region of electronic equilibrium, a homogeneous model corresponding to the material of the mesh cell may be applied with a weight equal to one. Thus this homogeneous model is the only model contributing to generating the dose at the points of electronic equilibrium. By approaching an interface between two materials, for example orthogonal to the beam, the electron regimes become disturbed. The influence of the pillar model of the mesh cell situated on the other side of the interface then becomes more appreciable as the interface is approached. The weighting applied to the model of the current mesh cell therefore decreases on approaching the interface whereas the weighting applied to the pillar model of the mesh cell situated on the other side of the interface increases. The weightings applied to the pillar models of the mesh cells situated on either side of the interface are therefore complementary and their sum is equal to one at every point. The weightings used are continuous functions according to the first position p, thus allowing continuous evolution of the dose deposition models.

A weighting used may be a sigmoid function whose neutral value may be placed for example two or three millimeters after the interface. The width necessary for the transition is of the order of the length necessary for attaining electronic equilibrium from the interface, that is to say the depth where the dose deposited is maximal in the case of a homogeneous phantom composed of the same material as the current mesh cell. Weightings of sigmoid type advantageously make it possible to ensure a slow and continuous transition, properly representing the fact that the models have a deep impact in the adjacent mesh cells which is related to the deposition of secondary dose, that is to say by secondary particles. However, the secondary dose being very small, the effects related to the electron instability in the vicinity of the interface are very small for the secondary dose.

Other transition functions having an influence that is more localized around the interface may be used: for example a linear weighting function or else a function such as

$$\frac{1}{1 + {( a \cdot z )}^{3}}$$

where a makes it possible to adjust the slope and is therefore directly related to the depth at which electronic equilibrium is established.

The choice between a linear function and a function of sigmoid type depends notably on the desired performance criteria for the method according to the invention.

The procedure using weightings is advantageously very accurate in the approximation of the dose depositions in proximity to the interfaces between materials of differing nature.

FIG. 8 represents what happens in respect of the scattering of the models when the beam is not parallel to the interfaces. As we have said, a scattering model, for geometric reasons, is not necessarily valid over the whole of the current mesh cell. It must be associated with a domain of validity. FIG. 8 shows the benefit of such a validation domain and an example of determining these domains. In FIG. 8, the beam 43 crosses the mesh cells 80, 81 and 82. The beam 43 scatters into the mesh cell 83. However this scattering is double. It occurs at both from the mesh cell 81 via the interface 84 and from the mesh cell 82 via the interface 85. If no validity domain were associated with each scattering model, they would be added together and in fact the scattering of the beam 43 would be counted twice. A first calculation of the validity domain can be done on geometric considerations with the aid of the planes substantially orthogonal to the axis of propagation of the beam and the interfaces through which scattering occurs. Thus, the model of scattering of the pillar model of the mesh cell 81 via the interface 84 will be valid only in the zone 85. The model of scattering of the pillar model of the mesh cell 82 via the interface 85 will be valid only in the zone 86. The two validity zones are complementary and the scattering of the beam 43 in the mesh cell 83 is taken into account everywhere just once.

Once these validity domains have been defined in a binary manner, it is possible to smooth these domains so as to make the transitions from one domain to the other more continuous and thus avoid threshold effects. They can be smoothed linearly or according to a sigmoidal form for example. The essential thing is that the sum of the validities of all the scattering models arising from one and the same beam or sub-beam must always be less than or equal to one.

If it is the choice of the procedure for weighting between models which is used for the corrective elements, the definition of the validity domain can then be advantageously integrated into the formula for determining the weightings.

A beam obliquely crossing an interface between two different materials produces a disequilibrium in fluence on the beam. The disequilibrium in fluence is then passed on to the dose distribution deposited by the beam. The disequilibria induced in the dose by an oblique interface are less appreciable than those induced in the primary fluence, by virtue notably of an effect of compensation between the various positions via the electron scatterings. However, interfaces that are highly inclined with respect to the beam, of the order of seventy degrees or more, give consequent deviations in dose, that should be modeled.

A first solution may be to enhance the projection so as to adapt the base model to these extreme situations.

A second solution, simple to implement, is to slice the beam into at least two primary sub-beams, thereby amounting to placing two pillar models on the mesh cell which have different equivalent depths for one and the same calculation point. This approach is similar to a quantization or a sampling, making it possible to reduce the complexity related to the oblique interface to two cases that are simple to treat.

Advantageously, this approach is simple and does not introduce any complex projections of the equivalent coordinates onto the homogeneous models. Moreover this approach requires little input data: mainly models of doses in the case where the beam is substantially orthogonal to the interface. This approach is also easily parametrizable, thus making it possible to curb the complexity of the method as a function of the accuracy desired for the results.

Advantageously, the dose calculation method according to the invention is very fast. Indeed, initially, only change of reference frame or projection formulae are calculated for each mesh cell of the phantom of the patient. For each mesh cell, a distribution of the dose deposited in this mesh cell is then available. By grouping together the voxels of one and the same homogeneous material into one or more mesh cells, the amount of data to be processed is thus advantageously reduced and allows faster calculations.

By performing the dose calculation for the whole set of voxels, the method according to the invention remains extremely fast.

Advantageously the method according to the invention can be applied to procedures for hadrontherapy, protontherapy and electron radiotherapy.

1. A method for calculating doses deposited by at least one beam of ionizing particles on voxels of a phantom of a patient, said phantom being meshed, each mesh cell of the phantom comprising voxels of one and the same material, said calculation method comprising the following steps for each beam:
a first step of calculating at least one analytical function for apportioning doses deposited by the first beam for each mesh cell of a set of mesh cells of the phantom, said first step comprising:
a first calculation of analytical function for first mesh cells of the phantom that are crossed by the first beam, the analytical functions thus obtained are pillar models; and
a second calculation of analytical functions for second mesh cells of the phantom, that are not crossed by the first beam, by scattering of the pillar models, by gradually traversing the second mesh cells of the phantom, starting from the mesh cells crossed by the first beam, so as to obtain scattering models for the mesh cells of the set of mesh cells which are not crossed by the first beam; and
a second step of calculating doses on several voxels of the mesh, the value of the dose for a voxel being the value of the analytical function for apportioning doses of the mesh cell to which the voxel belongs, at the position of the voxel in the mesh cell.

2. The method according to claim 1, wherein the set of mesh cells of the phantom comprises mesh cells for each of which at least one of the values of the analytical function on the mesh cell is greater than a given threshold.

3. The method according to claim 1, wherein an analytical function comprises at least two functions including:
a first projection function associating a first position of a mesh cell with a second position in a phantom of a homogeneous material, said homogeneous material having characteristics similar to the characteristics of the material of the voxels of the mesh cell; and
a second model function associating with the second position in the phantom of the homogeneous material a dose being deposited thereat by a second beam similar to the first beam.

4. The method according to claim 3, wherein the dose deposited by a beam in the phantom of homogeneous material is given by a base model pre-calculated by using a dose distribution obtained by a simulation according to a Monte Carlo procedure.

5. The method according to claim 3, wherein a scattering model comprises three functions including:
the first projection function;
the second model function; and
a third validity function associating with a third position in one of the second mesh cells, a degree of weighting applied to the second model function.

6. The method according to claim 1, wherein a calculation of analytical functions for apportioning doses is performed for two adjacent mesh cells of various materials, the second interface between the two mesh cells being crossed in an oblique manner by the first beam, by using a decomposition of the first beam into several sub-beams; said calculation of analytical functions being performed for each sub-beam in the same manner as for a beam.

7. The method according to claim 1, wherein a calculation of analytical functions for apportioning doses being performed for two adjacent mesh cells of various materials, the first beam propagating in a manner substantially parallel to the first interface, said calculation of analytical functions comprises a calculation of an analytical function per sub-beam, said first beam being decomposed into several sub-beams, said calculation of analytical functions being performed for each sub-beam in the same manner as for a beam.

8. The method according to claim 6, wherein an analytical function for apportioning doses deposited by the first beam is obtained through a weighted sum of the analytical functions associated with each sub-beam of the first beam, said weighting depending on a first position of a mesh cell.

9. The method according to claim 8, wherein the weighting is deduced from a normalization of first coefficients arising from a Gaussian shape function.

10. The method according to claim 8, wherein the weighting is deduced from a normalization of second coefficients arising from a function of the shape of a Bell function.

11. The method according to claim 1, wherein corrective elements are applied to an analytical function for apportioning doses for a fifth mesh cell, of different material relative to a sixth mesh cell adjacent to the fifth mesh cell, said corrective elements modeling an electronic discontinuity in proximity to a third interface between the fifth mesh cell and the adjacent sixth mesh cell.

12. The method according to claim 11, wherein the corrective elements are based on “shutdown” models signifying stopping models.

13. The method according to claim 11, wherein the corrective elements for a mesh cell are based on a weighted sum of the analytical functions of the mesh cell and of the analytical functions of the mesh cells adjacent to the mesh cell, said weighting depending on a first position in the mesh cell.
